(19) United States
(12) Patent Application Publication
(10) Pub. No.: US 2026/0336679 A1
(43) Pub. Date: Oct. 29, 2026

(54) LOAD BACKREST

(71) Applicant: Crown Equipment Corporation, New Bremen, OH (US)

(72) Inventors: Christian Ganzenmüller, Munich (DE); Lisa Schäfer, Munich (DE)

(21) Appl. No.: 19/652,317

(22) Filed: Apr. 20, 2026

Related U.S. Application Data
(60) Provisional application No. 63/793,706, filed on Apr. 24, 2025.

(51) Int. Cl. B62B 5/00; B62B 3/06

(52) U.S. Cl. CPC B62B 5/0053; B62B 3/0612; B62B 5/0013

(57) ABSTRACT

Load backrests for industrial vehicles include a frame attachable to a structure of the industrial vehicle. A body portion is coupled to the frame within an opening of the frame. The body portion includes an outer portion and vertical and/or horizontal frame braces. The outer portion includes a face section planar with the frame braces and at least one coupling section that extends transverse to the face section. At least one coupling section is joined to the face section via a bend in a material forming the body portion. The second section is coupled to the frame. Load backrests may further include a guard member pivotably coupled to a battery cover. Methods for accessing a battery include opening the battery cover that is rigidly coupled to the guard member, so as to move the guard member outside the opening of the frame to facilitate removal of the battery.

### CROSS-REFERENCES TO RELATED APPLICATIONS

This application claims benefit of priority under 35 U.S.C. § 119(e) to U.S. Provisional Application Ser. No. 63/793,706, filed Apr. 24, 2025, and incorporated by reference herein in its entirety.

### TECHNICAL FIELD

This application is directed to industrial vehicles and, more particularly, to load backrests for industrial vehicles and to methods for accessing a battery of an industrial vehicle that includes a load backrest.

### BACKGROUND

Industrial vehicles are commonly used for lifting loads in locations such as warehouses and distribution centers. When the industrial vehicle is configured so that the loads are positioned in front of the industrial vehicle before being lifted, the industrial vehicle may be equipped with a load backrest that prevents the load from moving backward when the load is lifted. Load backrests may need to be removed or exchanged with other backrests to accommodate various types of loads.

Industrial vehicles also may be powered by a battery stored in a battery compartment within a power unit of the industrial vehicle. The batteries normally require access for either charging or replacement.

### SUMMARY

According to a first aspect of this disclosure, a load backrest for an industrial vehicle includes a frame, a body portion, a face section, and at least one coupling section. The frame may be attachable to a side structure of the industrial vehicle so as to define an opening between the frame and a vehicle surface of the industrial vehicle. The body portion may be coupled to the frame within the opening of the frame. Further, the body portion may include an outer portion and a plurality of frame braces that extend at least one of vertically or horizontally from a first side of the outer portion to a second side of the outer portion opposite the first side. The outer portion may include a face section and at least one coupling section. The face section may be coplanar with the frame braces. The at least one coupling section extends transverse to the face section. The at least one coupling section is joined to the face section via a bend in a material forming the body portion. The second section is coupled to the frame.

In some examples according to the first aspect, the coupling section may be removably coupled to the frame via fasteners.

In some examples according to the first aspect, the fasteners may be bolts or screws.

In some examples according to the first aspect, a thickness of the frame in a longitudinal direction of the industrial vehicle may be greater than a thickness of the frame braces in the longitudinal direction of the industrial vehicle.

In some examples according to the first aspect, the frame braces may be located at a front side of the frame opposite from a battery compartment of the industrial vehicle.

In some examples according to the first aspect, the frame braces may extend vertically and horizontally in a grid pattern.

In some examples according to the first aspect, the frame braces may be integral with the outer portion.

In some examples according to the first aspect, the coupling section may include: an upper coupling section coupled to a top rail of the frame; a first side coupling section coupled to a first side rail of the frame; and a second side coupling section opposite the first side coupling section and coupled to a second side rail of the frame opposite the first side rail of the frame.

In some examples according to the first aspect, the upper coupling section may be joined to the face section via a first bend in the material forming the body portion; the first side coupling section may be joined to the face section via a second bend in the material forming the body portion; and the second side coupling section may be joined to the face section via a third bend in the material forming the body portion.

In some examples according to the first aspect, the first side coupling section and the second side coupling section do not engage the upper coupling section.

In some examples according to the first aspect, the frame may be formed from first and second frame sections that are joined together at top portions thereof.

According to a second aspect of this disclosure, an industrial vehicle may include a load backrest according to the first aspect of this disclosure.

According to a third aspect of this disclosure, a load backrest for an industrial vehicle includes a frame, a body portion, and a guard member. The frame is for attachment to a side structure of the industrial vehicle and defines an opening. The body portion is coupled to the frame in an upper portion of the opening of the frame and includes a plurality of frame braces that extend at least one of vertically or horizontally up to an outer portion of the body portion. The outer portion is coupled to the frame. The guard member is pivotably movable from a closed position in a lower portion of the opening to an open position outside the opening. The guard member is coupled to a battery cover that covers a battery when the guard member is in the closed position and exposes the battery when the guard member is in the open position. The guard member is not coupled to the frame or to the body portion.

In some examples according to the third aspect, the battery cover may be pivotably coupled to a battery compartment above the battery.

In some examples according to the third aspect, the guard member may be moved with the battery cover when the battery cover is opened.

In some examples according to the third aspect, the guard member may include a plurality of guard braces that extend at least one of vertically or horizontally within the lower portion of the opening when the guard member is in the closed position.

In some examples according to the third aspect, the guard braces may extend vertically and horizontally in a grid pattern.

In some examples according to the third aspect, a thickness of the frame in a longitudinal direction of the industrial vehicle may be greater than a thickness of the frame braces in the longitudinal direction of the industrial vehicle.

In some examples according to the third aspect, the frame braces may be located at a front side of the frame opposite from a battery compartment of the industrial vehicle that houses the battery.

In some examples according to the third aspect, the frame braces may extend vertically and horizontally in a grid pattern.

In some examples according to the third aspect, the frame braces may be integral with the outer portion.

In some examples according to the third aspect, the body portion may fill at least 50% of the opening and the guard member may fill less than 50% of the opening.

In some examples according to the third aspect, the body portion may fill at least 75% of the opening and the guard member may fill less than 25% of the opening.

In some examples according to the third aspect, the outer portion of the body portion may include a face section and at least one coupling section. The face section may be planar with the frame braces. The at least one coupling section may extend transverse to the face section. The at least one coupling section may be joined to the face section via a bend in a material forming the body portion. The second section may be coupled to the frame.

In some examples according to the third aspect, the coupling section may be removably coupled to the frame via fasteners.

According to a fourth aspect of this disclosure, an industrial vehicle may include a load backrest according to the third aspect of this disclosure.

According to a fifth aspect of this disclosure, methods for accessing a battery of an industrial vehicle are provided. The industrial vehicle includes a vehicle body having a battery compartment that houses the battery; a load handling assembly; and a load backrest coupled to a side structure of the industrial vehicle adjacent to the load handling assembly. The methods include opening a battery cover that is rigidly coupled to the guard member to simultaneously expose the battery and move at least a portion of the guard member outside the opening.

In some examples according to the fifth aspect, opening the battery cover may cause at least a portion of the battery cover to enter the opening in the frame.

In some examples according to the fifth aspect, opening the battery cover may include pivotably opening the battery cover in a direction toward the load handling assembly.

In some examples according to the fifth aspect, at least a majority of the battery cover may clear the opening in the frame when the battery cover is opened.

In some examples according to the fifth aspect, a thickness of the frame in a longitudinal direction of the industrial vehicle may be greater than a thickness of the frame braces in the longitudinal direction of the industrial vehicle.

In some examples according to the fifth aspect, the frame braces may be located at a front side of the frame opposite from the battery compartment of the industrial vehicle.

In some examples according to the fifth aspect, the frame braces may extend vertically and horizontally in a grid pattern.

In some examples according to the fifth aspect, the frame braces may be integral with the outer portion.

In some examples according to the fifth aspect, when the battery cover is open, the battery of the industrial vehicle may be upwardly extractable from the battery compartment without removing the load backrest and without adjusting the frame to accommodate extraction of the battery.

In some examples according to the fifth aspect, the load backrest may be a load backrest according to the third aspect of this disclosure.

These and other features, aspects, and advantages will become better understood with reference to the following description and the appended claims.

Additional features and advantages of the embodiments described herein will be set forth in the detailed description that follows, and in part will be readily apparent to those skilled in the art from that description or recognized by practicing the embodiments described herein, including the detailed description that follows, the claims, as well as the appended drawings.

It is to be understood that both the foregoing general description and the following detailed description describe various embodiments and are intended to provide an overview or framework for understanding the nature and character of the claimed subject matter. The accompanying drawings are included to provide a further understanding of the various embodiments, and are incorporated into and constitute a part of this specification. The drawings illustrate the various embodiments described herein, and together with the description serve to explain the principles and operations of the claimed subject matter.

### BRIEF DESCRIPTION OF THE DRAWINGS

FIG. 1 is a perspective view of an industrial vehicle including an example of a load backrest disclosed herein, with frame and body portion.

FIG. 2 is a perspective view of an industrial vehicle including only a frame of an example of a load backrest disclosed herein, without the body portion.

FIG. 3 is a front perspective view of an upper portion of an example configuration of a frame of the load backrest disclosed herein.

FIG. 4 is a rear perspective view of an upper portion of an example configuration of a body portion of the load backrest disclosed herein.

FIG. 5 is a front perspective view of an upper portion of an example load backrest including the frame of FIG. 3 and the body portion of FIG. 4.

FIG. 6 is a back perspective view of the upper portion of the load backrest of FIG. 5.

FIG. 7A is a perspective view hypothetically superimposing an open battery compartment of an industrial vehicle over a conventional load backrest, showing how a battery inside the open battery compartment cannot be extracted.

FIG. 7B is a perspective view of a battery compartment of an industrial vehicle having a load backrest according to embodiments herein, showing how a battery inside the open battery compartment is freely extractable.

FIG. 7C is a perspective view overlaying the conventional load backrest of FIG. 7A in solid lines and the load backrest according to embodiments herein in phantom lines.

FIG. 8 is a partial front perspective view of a portion of an industrial vehicle including a load backrest with a guard member as disclosed herein.

FIG. 9 is a partial back perspective view of a portion of an industrial vehicle including a load backrest with a guard member as disclosed herein.

FIG. 10 is a partial side view of a portion of an industrial vehicle including a load backrest with a guard member as disclosed herein.

FIG. 11 is a partial front perspective view of a portion of an industrial vehicle including a load backrest with a guard member as disclosed herein, in which the guard member is in an open position to expose a battery compartment of the industrial vehicle.

FIG. 12 is a partial side view of a portion of an industrial vehicle including a load backrest with a guard member as disclosed herein, in which the guard member is in an open position to expose a battery compartment of the industrial vehicle.

FIG. 13 is a partial side view of a portion of an industrial vehicle including a load backrest with a guard member as disclosed herein, in which the guard member is in an open position to expose a battery compartment of the industrial vehicle, including a battery being moved into or out of the battery compartment.

FIG. 14 is a flowchart of an example method for accessing a battery of an industrial vehicle, as disclosed herein.

FIG. 15 is a perspective view of another kind of industrial vehicle, specifically a walkie truck, including an example of a load backrest disclosed herein, with frame and body portion.

### DETAILED DESCRIPTION

The following Detailed Description broadly describes numerous embodiments. The description is to be construed as exemplary only and not as describing every possible embodiment. It should be understood that any feature, characteristic, component, composition, ingredient, product, step, or methodology described herein can be deleted, combined with or substituted for any other feature, characteristic, component, composition, ingredient, product, step, or methodology described herein, in whole or in part. It should be understood that multiple combinations of the embodiments described and shown are contemplated and that a particular focus on any one embodiment does not preclude its inclusion in a combination of other described embodiments. It should be understood that numerous alternative embodiments can be implemented that would still fall within the scope of the claims by applying either current technology or even technology yet undeveloped as of the filing date. All publications and patents cited herein are incorporated herein by reference in their entirety.

Some embodiments herein are directed to load backrests for industrial vehicles. Further embodiments herein are directed to load backrests for industrial vehicles, in which the load backrests include a guard member adapted to facilitate removal of a battery from the industrial vehicle. Still further embodiments herein are directed to methods for accessing a battery of an industrial vehicle including a load backrest according to embodiments herein.

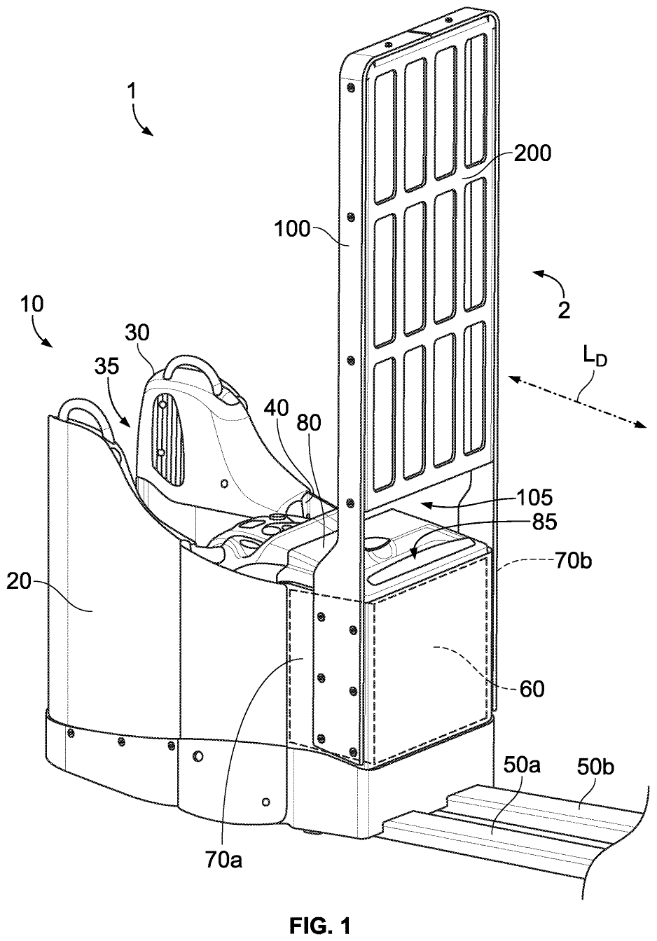

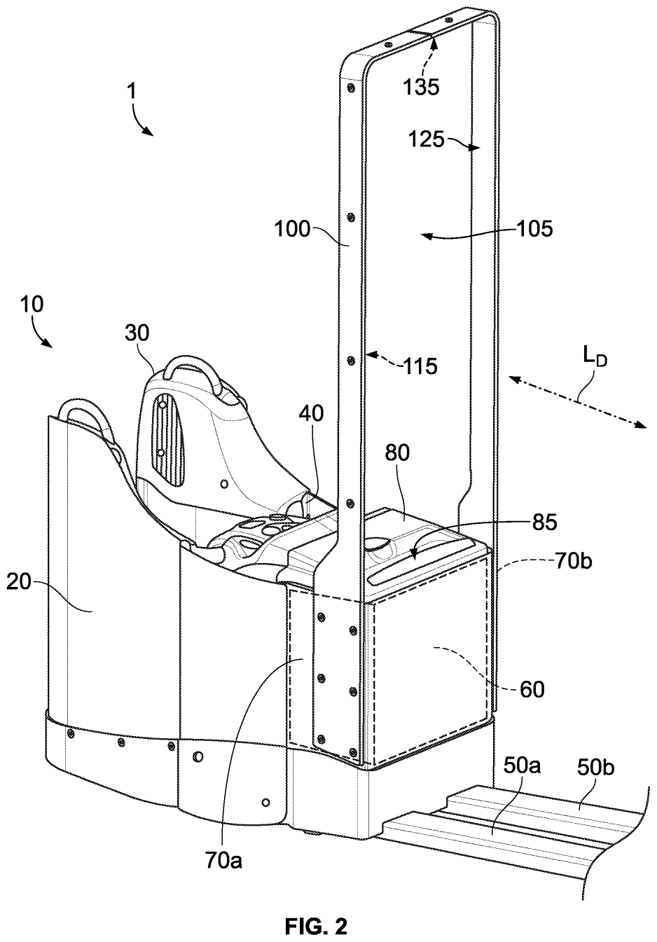

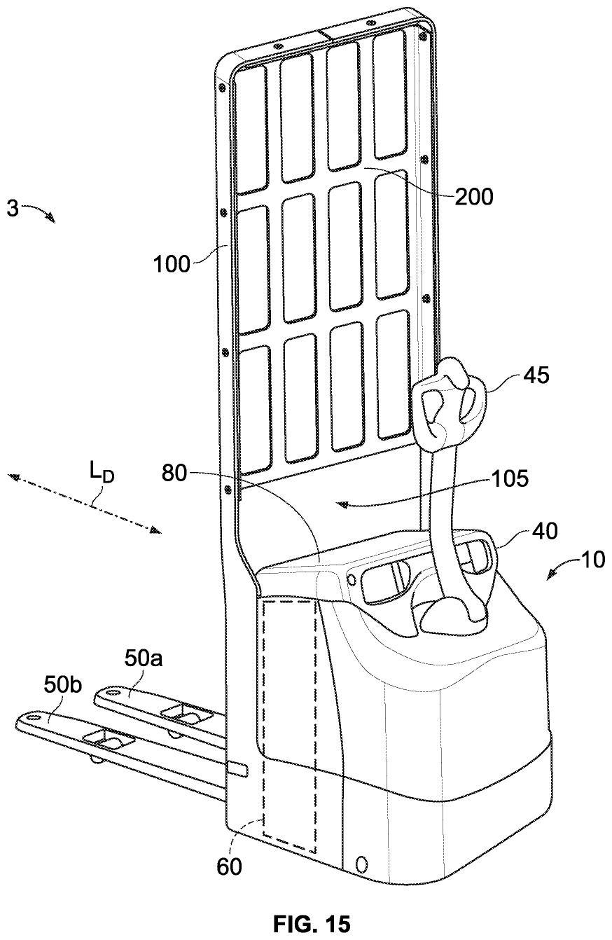

FIG. 1 is a perspective view of an example of an industrial vehicle 1 that includes a load backrest 2 according to embodiments herein. FIG. 2 is a perspective view of the same industrial vehicle 1 in FIG. 1, in which the body portion 200 of the load backrest 2 has been removed. Though FIGS. 1 and 2 exemplify the industrial vehicle 1 as a lift truck, it should be understood that the load backrest 2 may have application on any kind of industrial vehicle requiring a backrest for supporting a load and/or for protecting an operator behind a load that the industrial vehicle is lifting. For example, the industrial vehicle may be a walkie truck 3, as shown in FIG. 15.

Generally, as applicable to FIGS. 1, 2, and 15, industrial vehicles may have in common a vehicle body 10, operator controls 40, a battery compartment 60 in which a battery is removably installable, and a battery cover 80 over the battery compartment 60. The industrial vehicle may be a load handling vehicle such as a forklift having a pair of forks 50a, 50b operably connected to the vehicle body 10 and configured to raise and lower a load. The vehicle body 10 of the industrial vehicle 1 of FIGS. 1 and 2 includes a first body side 20 and a second body side 30 opposite the first body side 20. In this arrangement, an operator may stand in an operator station 35 between the first body side 20 and the second body side 30 to control the industrial vehicle 1 by manipulating the operator controls 40. As an alternative, when the industrial vehicle is a walkie truck 3 as in FIG. 15, an operator may stand in an operator station defined behind the vehicle body 10 and maneuver the walkie truck 3 with a steering handle 45.

Referring to FIGS. 1 and 2, the load backrest 2 for the industrial vehicle 1 includes a frame 100 and a body portion 200. The frame 100 will be described now with reference to FIGS. 1-3 and 5; the body portion will be described subsequently with reference to FIGS. 1, 4, and 5.

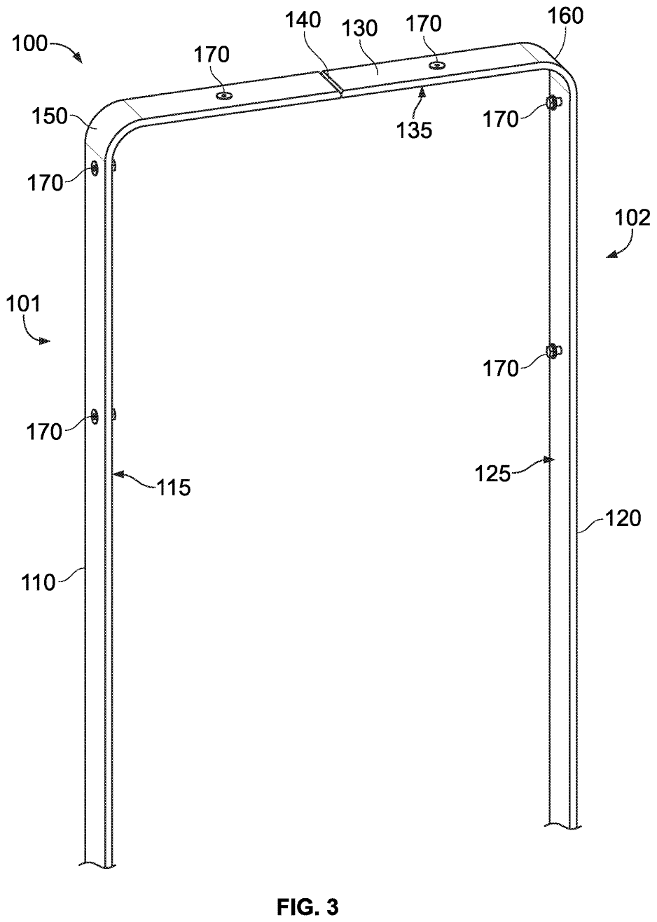

Referring to FIGS. 1-3 and 5, the frame 100 includes a first side rail 110, a second side rail 120, and a top rail 130. The first side rail 110 has a first inner surface 115. The second side rail 120 has a second inner surface 125. The top rail 130 has a third inner surface 135. The frame 100 may be constructed as a single piece or as two freestanding pieces that optionally are permanently joined, e.g., by welding or by mechanical reinforcement such as a collar or a fastener. In the embodiment of FIG. 3, the first side rail 110, the second side rail 120, and the top rail 130 are formed from two pieces that meet or are permanently joined at a seam 140, such that the first side rail 110 and half the top rail 130 are formed from a first frame section 101 bent at a first frame bend 150 and such that the second side rail 120 and the other half of the top rail 130 are formed from a second frame section 102 bent at a second frame bend 160. In other words, the frame 100 may be formed from a first frame section 101 and a second frame section 102 that are joined together at respective top portions thereof, for example, at the seam 140, which may comprise a weld.

The frame 100 may further include at least one fastener hole 170 configured to enable fastening of the body portion 200 within an opening 105 of the frame 100, as will be described. When the frame 100 is not attached to the industrial vehicle 1, the opening 105 is defined within an area between the first side rail 110 and the second side rail 120 and underneath the top rail 130, namely, an area bounded by the first inner surface 115 of the first side rail 110, the second inner surface 125 of a second side rail 120, and the third inner surface 135 of the top rail 130.

Referring again to FIGS. 1 and 2, the frame 100 may be attached to a side structure 70a, 70b of the industrial vehicle 1. For example, the first side rail 110 of the frame 100 may be attached to a first side structure 70a on the first side 20 of the industrial vehicle 1 and the second side rail 120 of the frame 100 may be attached to a second side structure 70b on the second side 30 of the industrial vehicle 1. When the frame 100 is attached to the side structure 70a, 70b of the industrial vehicle 1, the frame 100 defines the opening 105. In particular, the opening 105 is an essentially four-sided opening within an area defined by or bounded by the first inner surface 115 of the first side rail 110 of the frame 100, the second inner surface 125 of the second side rail 120 of the frame, the third inner surface 135 of the top rail 130 of the frame 100, and a top surface 85 of the vehicle body 10 of the industrial vehicle 1.

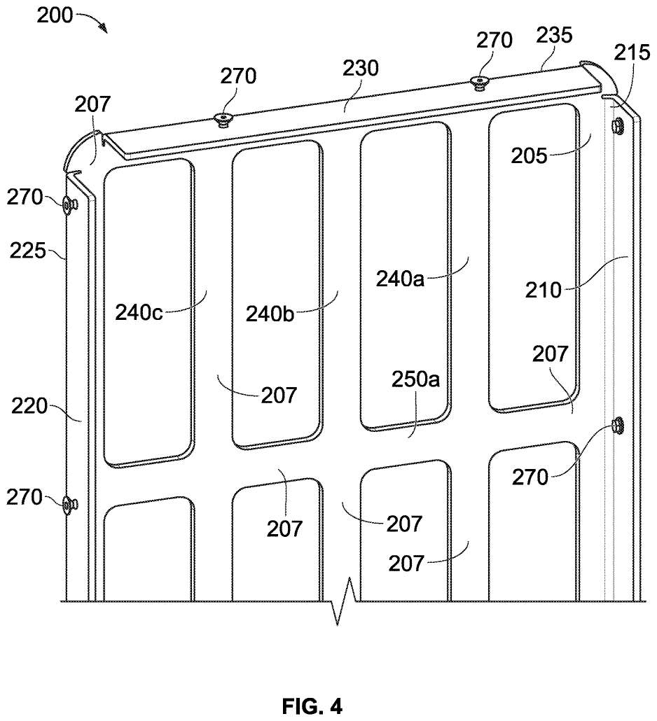

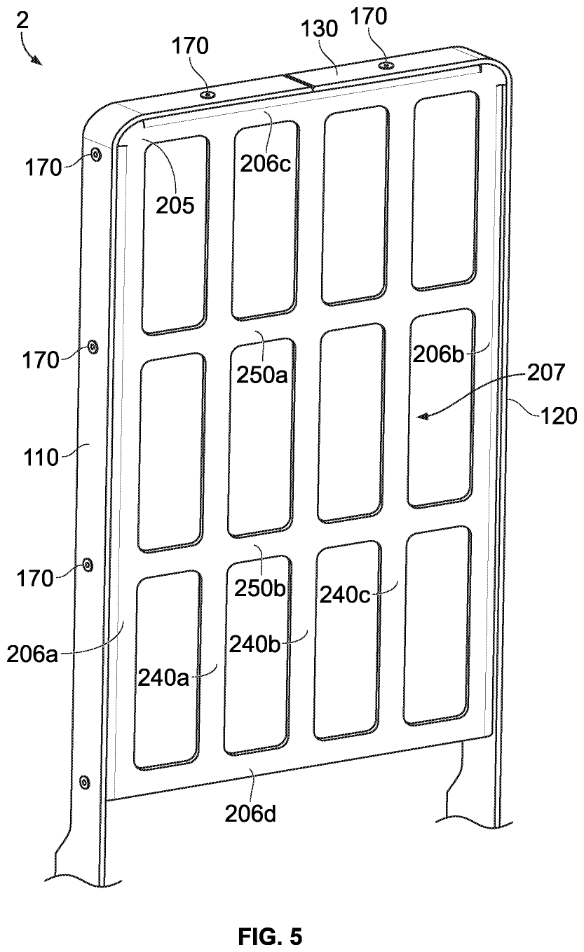

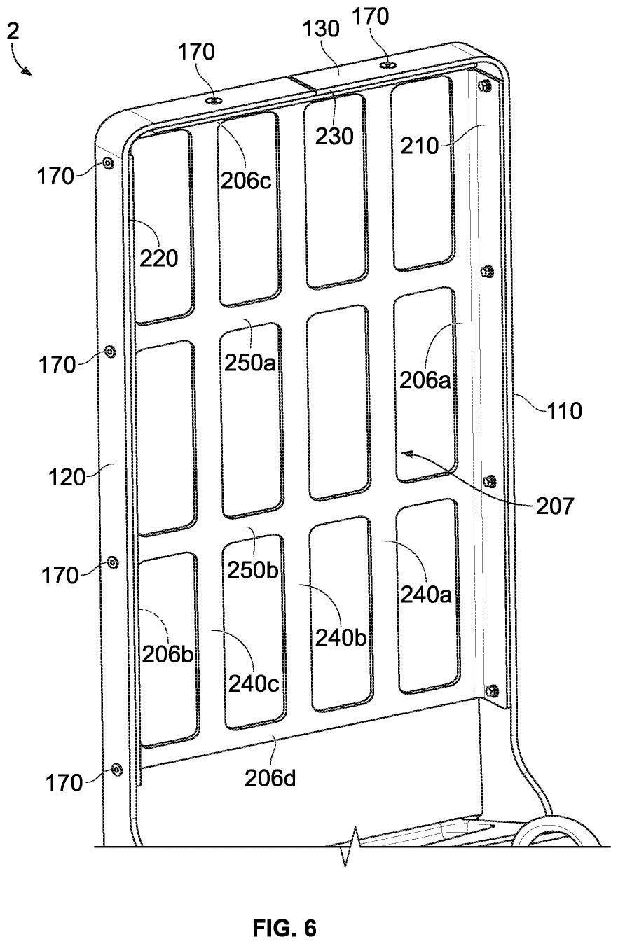

The body portion 200 of the load backrest 2 will now be described with reference to FIGS. 1, 4, and 5. In FIG. 1, the body portion 200 is attached to the frame 100 of the load backrest 2. FIG. 4 is a back view of the body portion 200 in isolation. FIG. 5 is a front view of the body portion 200 within the frame 100.

Referring initially to FIGS. 4 and 5, the body portion 200 includes an outer portion 205 and a plurality of frame braces 240a, 240b, 240c, 250a, 250b. The outer portion 205 defines a perimeter of the body portion 200 and includes means for coupling the body portion 200 to the frame 100. The perimeter of the body portion 200 may be configured according to any desired shape or size, most commonly as a rectangle, a rounded rectangle (as in FIGS. 4 and 5), or an oval. The frame braces 240a, 240b, 240c, 250a, 250b provide a primary barrier of the load backrest 2 to prevent a load being handled by the industrial vehicle 1 from moving backward, i.e., toward the operator station 35. In one example, the frame braces 240a, 240b, 240c, 250a, 250b extend at least one of vertically (as in vertical frame braces 240a, 240b, 240c) or horizontally (as in horizontal frame braces 250a, 250b) from a first side 206a, 206c of the outer portion 205 to a respective second side 206b, 206d of the outer portion 205 opposite the first side 206a, 206c.

For example, as more readily apparent in FIG. 5, horizontal frame braces 250a, 250b extend horizontally from a first side (left side 206a) of the outer portion 205 to a second side (right side 206b) of the outer portion 205, and vertical frame braces 240a, 240b, 240c extend vertically from a first side (top side 206c) of the outer portion 205 to a second side (bottom side 206d) of the outer portion 205. In the non-limiting examples of FIGS. 4 and 5, the frame braces 240a, 240b, 240c, 250a, 250b extend vertically and horizontally in a grid pattern. It should be understood, however, that the frame braces may be arranged in any manner or configuration to ensure that the frame braces prevent a load being handled by the industrial vehicle to move backward toward the operator in the operator compartment 35.

As previously described, the outer portion 205 defines a perimeter of the body portion 200 and includes means for coupling the body portion 200 to the frame 100. In particular, the outer portion 205 of the body portion 200 includes a face section 207 and at least one coupling section 210, 220, 230, see FIG. 4. The at least one coupling section 210, 220, 230 provides the means for coupling the body portion 200 to the frame 100 in the example embodiment shown. The face section 207 is generally the part of the outer portion 205 that is not a coupling section 210, 220, 230. The face section 207 is coplanar with the frame braces 240a, 240b, 240c, 250a, 250b. The at least one coupling section 210, 220, 230 extends transverse to the face section 207. The at least one coupling section 210, 220, 230 is joined to the face section 207 via respective bends 215, 225, 235 in a material forming the body portion 200.

The number and arrangement of the coupling sections 210, 220, 230 of the body portion 200 may be varied, provided the body portion 200 can be sturdily coupled to the frame 100 with the number of coupling sections chosen and their configuration. As one non-limiting example as shown in FIGS. 4 and 5, the at least one coupling section 210, 220, 230 may include a first side coupling section 210 coupled to the first side rail 110 of the frame 100, a second side coupling section 220 opposite the first side coupling section 210 and coupled to the second side rail 120 of the frame 100, and an upper coupling section 230 coupled to the top rail 130 of the frame 100. In the same non-limiting example, the upper coupling section 230 may be joined to the face section 207 via a first bend 235 in the material forming the body portion 200; the first side coupling section 210 may be joined to the face section 207 via a second bend 215 in the material forming the body portion 200; and the second side coupling section 220 may be joined to the face section 207 via a third bend 225 in the material forming the body portion 200. In one configuration, the first side coupling section 210 and the second side coupling section 220 do not engage the upper coupling section 230.

In the load backrest according to embodiments, the face section 207 is coupled to the frame 100. Referring again to FIG. 1, in the load backrest 2 according to embodiments, the body portion 200 is removably coupled or permanently coupled to the frame 100 within the opening 105 defined by the frame 100. For example, the body portion 200 may be removably coupled to the frame 100 via fasteners 270. Individual fasteners may be identical or different and need only be capable of sturdily coupling the body portion 200 to the frame 100 in a manner sufficient to prevent failure of the coupling when a load is present on the industrial vehicle 1. Non-limiting examples of fasteners in this regard include bolts, screws, or combinations thereof. Alternatively, the frame 100 may be permanently coupled to the body portion 200 by welding any or all of the at least one coupling section 210, 220, 230 of the body portion 200 to the frame 100, for example.

In some example configurations of the load backrest 2, a thickness of the frame 100 in a longitudinal direction LD of the industrial vehicle 1 is greater than a thickness of the frame braces 240a, 240b, 240c, 250a, 250b in the longitudinal direction LD of the industrial vehicle 1. The longitudinal direction LD of the industrial vehicle 1 in this sense is defined from front to rear of the industrial vehicle 1, namely, perpendicular to the plane of the frame 100, as shown in FIG. 1.

In some example configurations of the load backrest, the load backrest 2 is configured so that, when the load backrest 2 is attached to an industrial vehicle 1, the frame braces 240a, 240b, 240c, 250a, 250b are located at a front side of the frame 100 opposite from the battery compartment 60 of the industrial vehicle 1. In such a configuration, the coupling sections 210, 220, 230 of the body portion 200 may be bent toward the rear of the industrial vehicle 1 when the frame 100 is attached to the side structures 70a, 70b of the industrial vehicle 1.

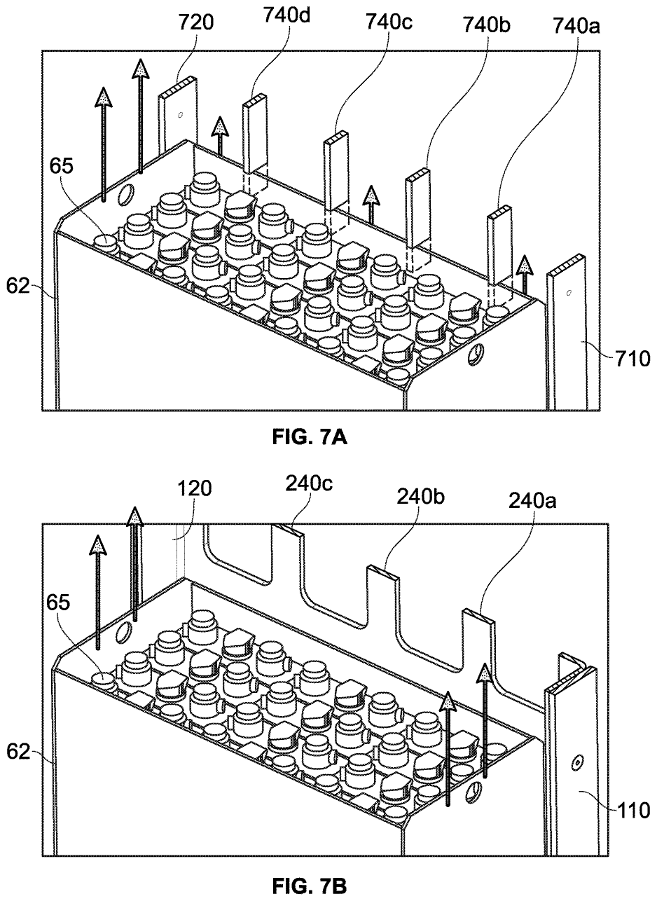

The load backrest 2 according to embodiments herein advantageously facilitates installation or removal of a battery from the industrial vehicle 1 when the battery compartment 60 is located behind the load backrest 2. FIGS. 7A, 7B, and 7C illustrate a battery removal from an industrial vehicle, in which a battery compartment 60 is located at the front of the industrial vehicle 1, adjacent to and just behind the load backrest 2.

Referring to FIG. 7A, conventional arrangements for load backrests include side bars 710, 720, and vertical cage bars 740a, 740b, 740c. However, the vertical cage bars 740a, 740b, 740c typically extend sufficiently far toward the rear of the vehicle that, when the battery 65 is raised to a certain height, the vertical cage bars 740a, 740b, 740c impede or prevent a battery housing 62 containing a battery 65 from being removed from the battery compartment 60 of the industrial vehicle 1, as shown in FIG. 7A where the vertical cage bars 740a, 740b, 740c are shown extending into a space that would be required to raise the battery housing 62 with the battery 65 being pulled out of the battery compartment 60. Typically, the only solution is to remove the load backrest entirely, at the expense of time and labor. Such conventional arrangements may be acceptable if a battery is routinely recharged while the industrial vehicle is inactive for a long recharging period but is extracted from the industrial vehicle only when the battery needs to be replaced. In contrast, when the load backrest does not need to be removed, a battery with only a depleted charge can be replaced easily with a battery having a full charge, to avoid a long period of charging-related inactivity.

Referring to FIG. 7B, the cutaway view of the frame braces 240a, 240b, 240c of the body portion 200 of the load backrest 2 according to embodiments herein provide sufficient clearance for the battery housing 62 to be removed from the industrial vehicle 1 without need to remove the load backrest 2. FIG. 7C is an overlay comparison, in which the frame braces 240a, 240b, 240c of the body portion 200 of the load backrest 2 according to embodiments herein are included in phantom lines behind the vertical cage bars 740a, 740b, 740c of a conventional load backrest, indicating with large “X” graphics how the battery 65 is impeded by the conventional load backrest since the vertical cage bars 740a, 740b, 740c extend into the space that would be required to raise the battery housing 62 with the battery 65 being pulled out of the battery compartment 60.

Further embodiments herein include an industrial vehicle 1 including the load backrest 2 in any aspect or configuration as previously described herein to include the frame 100 and the body portion 200 coupled to the frame 100.

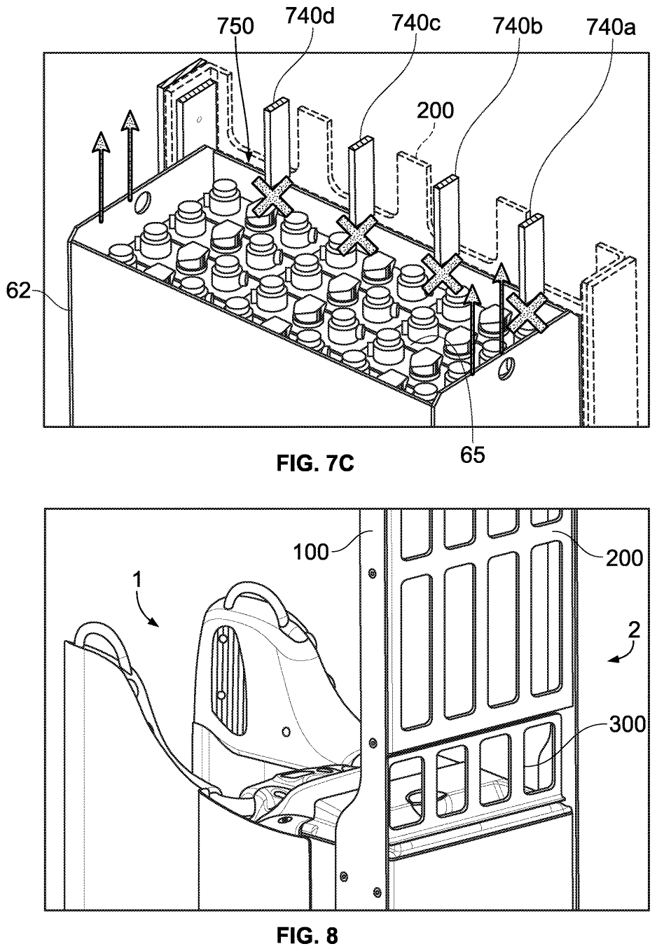

Additional embodiments of load backrests will now be described that include features of the load backrests previously described and further include a guard member adapted to facilitate removal of a battery from the industrial vehicle. Referring first to FIG. 8 as exemplary, in the additional embodiments, the load backrest 2 for an industrial vehicle 1 includes a frame 100 attachable to the industrial vehicle 1, a body portion 200 coupled to the frame 100, and a guard member 300.

As in the embodiments described with reference to FIG. 2, the frame 100 is configured for attachment to a side structure 70a, 70b of the industrial vehicle 1 and defines an opening 105. The body portion 200 is coupled to the frame 100 as described previously with reference to FIG. 2. However, the coupling of the body portion 200 when the load backrest 2 includes a guard member 300 is in an upper portion of the opening 105 of the frame 100. Thereby, a larger open space is present between the body portion 200 and the vehicle surface 85 of the industrial vehicle 1. The body portion 200 includes a plurality of frame braces 240a, 240b, 240c, 250a, 250b that extend at least one of vertically or horizontally to an outer portion of the body portion. The outer portion 205 of the body portion 200 is coupled to the frame 100.

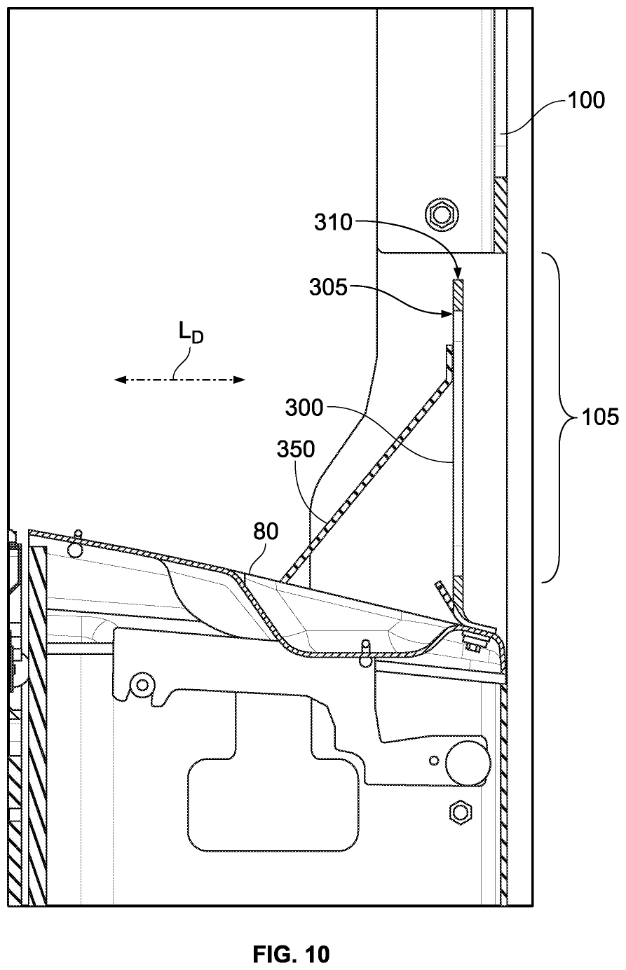

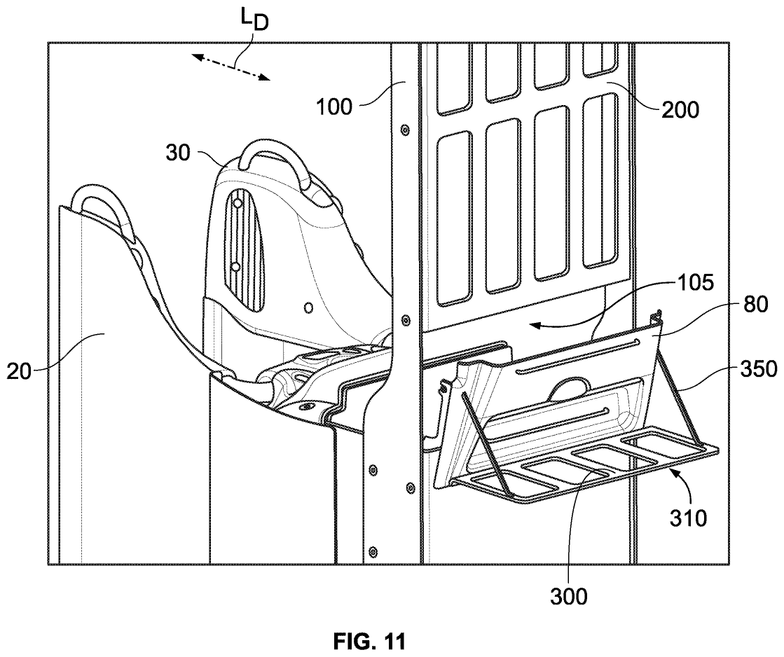

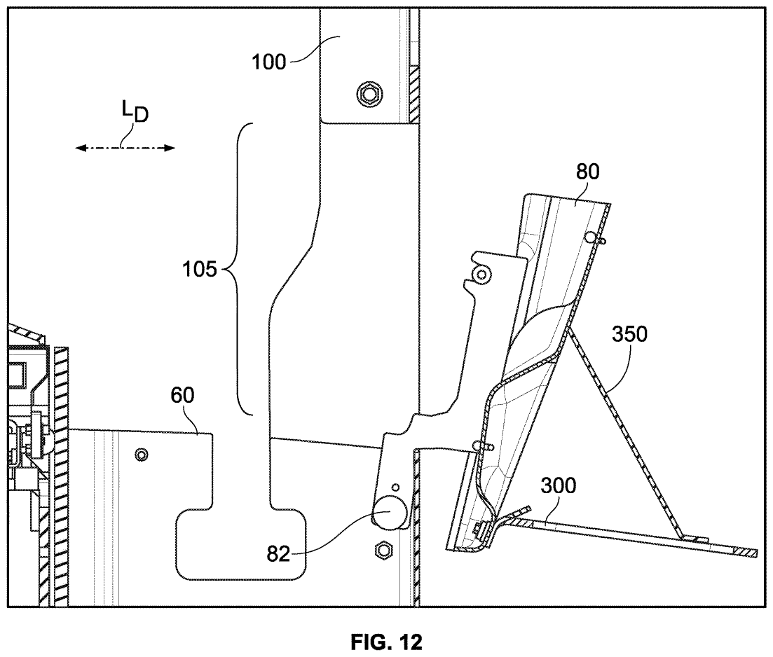

The guard member 300 is configured to have a closed position and an open position. In FIGS. 8, 9, and 10, the guard member is shown in the closed position. In FIGS. 11 and 12, the guard member 300 is shown in the open position. The guard member 300 is pivotably movable from the closed position, in which the guard member 300 is disposed in a lower portion of the opening 105 of the frame 100, to an open position, in which the guard member is disposed outside the opening 105 of the frame 100. More specifically, in the closed position of the guard member 300, a top guard surface 310 of the guard member 300 is disposed in the lower portion of the opening 105 of the frame 100 as the guard member 300 stands essentially vertically in a plane parallel to the body portion 200. Similarly, in the open position of the guard member 300, the top guard surface 310 is disposed outside the opening 105 of the frame 100 as the guard member 300 is oriented away from the vehicle body 10 of the industrial vehicle 1 at an angle of, for example, from 45 degrees to 135 degrees, measured from the orientation of the side bars 110, 120 of the frame 100. In some examples, the guard member 300 is moved with a battery cover 80 when the battery cover 80 is opened, or even at any time the battery cover 80 is opened. Thus, the guard member 300 may be moved to open the battery cover 80, or the battery cover 80 may be moved to open the guard member 300.

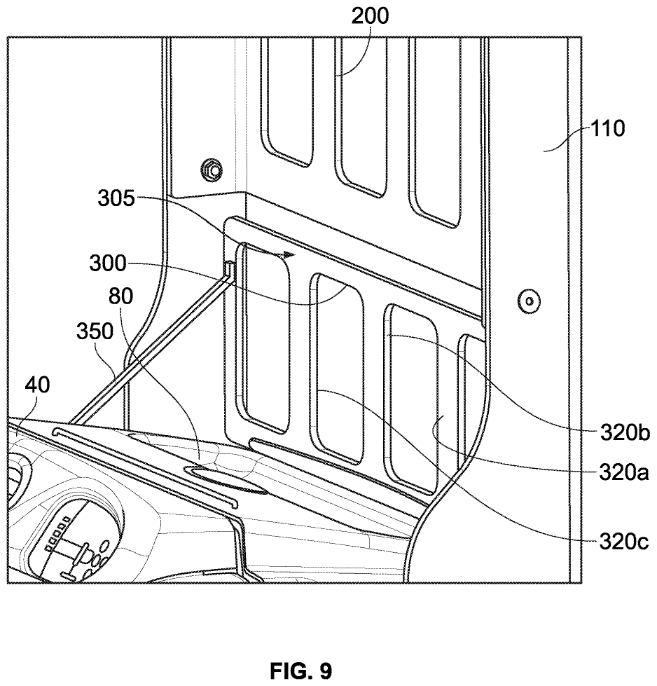

The guard member 300 is coupled to the battery cover 80 that covers a battery or a battery compartment 60 of the industrial vehicle 1 when the guard member is in the closed position and exposes the battery or the battery compartment 60 when the guard member 300 is in the open position. As evident in FIGS. 9, 11, and 12, the pivotable coupling of the guard member 300 with the battery cover 80 may be facilitated by a coupling bar 350 or a pair of coupling bars attached to a rear face 305 of the guard member 300 on one side and to the battery cover 80 on an opposite side.

According to embodiments, the guard member 300 is not directly coupled to the frame 100 or to the body portion 200. That is, movement of the guard member 300 from the closed position to the open position, or vice versa, does not in any way affect the frame or the body portion 200 of the load backrest 2.

In some examples of the load backrest 2 including the guard member 300, the battery cover 80 is pivotably coupled to a battery compartment 60 of the industrial vehicle 1 above the battery. An example of such a coupling is most evident in FIG. 12, in which the cover mechanism 82 pivotably couples the battery cover 80 to the battery compartment 60, so that the battery cover 80 opens toward the front of the industrial vehicle 1.

In some examples of the load backrest 2 including the guard member 300, and as shown in FIG. 9, the guard member 300 may include a plurality of guard braces 320a, 320b, 320c that extend at least one of vertically or horizontally within the lower portion of the opening 105 when the guard member 300 is in the closed position. Though in FIG. 9, the guard member 300 includes three guard braces 320a, 320b, 320c that extend vertically, it should be understood that numerous alternate arrangements are possible with more or fewer guard braces and/or including horizontal guard braces. For example, the guard braces may be configured to extend vertically and horizontally in a grid pattern.

In some examples of the load backrest 2 including the guard member 300, a thickness of the frame 100 in a longitudinal direction LD from the front of the industrial vehicle 1 to the rear of the industrial vehicle 1 is greater than a thickness of the frame braces 240a, 240b, 240c, 250a, 250b in the longitudinal direction LD of the industrial vehicle.

In some examples of the load backrest 2 including the guard member 300, the frame braces 240a, 240b, 240c, 250a, 250b are located at a front side of the frame 100 opposite from a battery compartment 60 of the industrial vehicle 1 that houses the battery 65.

In some examples of the load backrest 2 including the guard member 300, the frame braces 240a, 240b, 240c, 250a, 250b extend vertically and horizontally in a grid pattern.

In some examples of the load backrest 2 including the guard member 300, the frame braces 240a, 240b, 240c, 250a, 250b are integral with the outer portion 205 of the frame 100.

In some examples of the load backrest 2 including the guard member 300, the body portion 200 fills at least 50% of the opening 105 and the guard member 300 fills less than 50% of the opening 105.

In some examples of the load backrest 2 including the guard member 300, the body portion 200 fills at least 75% of the opening 105 and the guard member 300 fills less than 25% of the opening 105.

In some examples of the load backrest 2 including the guard member 300, the outer portion 205 of the body portion 200 includes a face section 207 and at least one coupling section 210, 220, 230. The face section 207 is coplanar with the frame braces 240a, 240b, 240c, 250a, 250b. The at least one coupling section 210, 220, 230 extends transverse to the face section 207 and is joined to the face section 207 via respective bends 215, 225, 235 in a material forming the body portion 200. The face section 207 is coupled to the frame 100.

In some examples of the load backrest 2 including the guard member 300, the coupling section 210, 220, 230 is removably coupled to the frame 100 via fasteners 270.

Further embodiments herein include an industrial vehicle 1 including the load backrest 2 with a guard member 300 in any aspect or configuration as previously described herein to include the frame 100, the body portion 200 coupled to the frame 100, and the guard member 300 coupled to a battery cover 80 of the industrial vehicle 1.

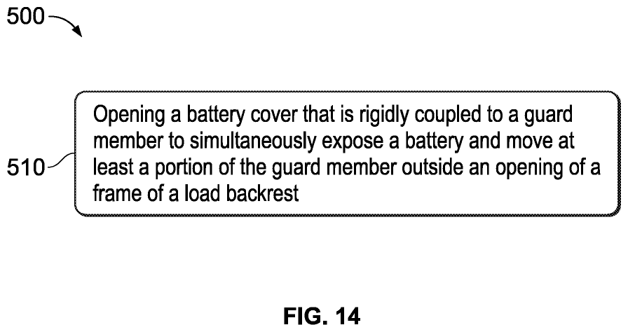

Further embodiments herein include methods for accessing a battery of an industrial vehicle. Referring to FIGS. 1 and 14, a method 500 for accessing the battery 65 of an industrial vehicle involves an industrial vehicle 1 including a vehicle body 10, a load handling assembly (for example, a pair of forks 50a, 50b; see FIG. 1), and a load backrest 2 as described herein, coupled to a side structure 70a, 70b of the industrial vehicle 1 adjacent to the load handling assembly 50a, 50b. The vehicle body 10 includes a battery compartment 60 that houses the battery 65.

The method 500 for accessing the battery of the industrial vehicle includes step 510 opening a battery cover 80 of the industrial vehicle 1 that is rigidly coupled to the guard member 300 to simultaneously expose the battery 65 and move at least a portion of the guard member 300 outside the opening 105.

In some examples of the methods for accessing the battery of the industrial vehicle, opening the battery cover 80 causes at least a portion of the battery cover 80 to enter the opening 105 in the frame 100, as is evident in FIGS. 11 and 12.

Referring to FIGS. 1 and 11, in some examples of the methods for accessing the battery of the industrial vehicle, opening the battery cover 80 comprises pivotably opening the battery cover 80 in a direction toward the load handling assembly 50a, 50b. In some examples, at least a majority of the battery cover 80 clears the opening 105 in the frame 100 when the battery cover 80 is opened.

In some examples of the methods for accessing the battery of the industrial vehicle, a thickness of the frame 100 in a longitudinal direction LD of the industrial vehicle 1 is greater than a thickness of the frame braces 240a, 240b, 240c, 250a, 250b in the longitudinal direction LD of the industrial vehicle 1.

In some examples of the methods for accessing the battery of the industrial vehicle, the frame braces 240a, 240b, 240c, 250a, 250b are located at a front side of the frame 100 opposite from the battery compartment 60 of the industrial vehicle 1. In some examples, the frame braces 240a, 240b, 240c, 250a, 250b extend vertically and horizontally in a grid pattern. In some examples, the frame braces 240a, 240b, 240c, 250a, 250b are integral with the outer portion 205.

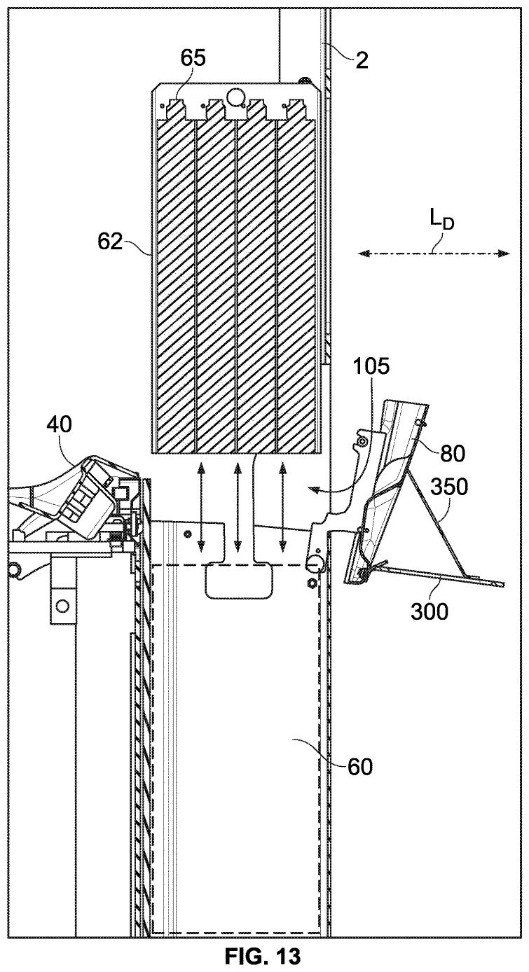

Referring to FIG. 13, in some examples of the methods for accessing the battery of the industrial vehicle, opening the battery cover 80 allows the battery 65 to be extracted from the battery compartment 60 without removing the load backrest 2 or adjusting the frame 100. This capability is present, because the outer portion 205 of the frame 100 is sufficiently forward, such that the frame braces 240a, 240b, 240c, 250a, 250b do not impede upward lifting of the battery 65. Thus, when the battery cover 80 is open, the battery 65 of the industrial vehicle 1 is upwardly extractable from the battery compartment 60 without removing the load backrest 2 and without adjusting the frame 100 to accommodate extraction of the battery 65.

The load backrests herein provide an ability for a battery of an industrial vehicle to be removed from a battery compartment without requiring downtime from removing the load backrest or adjusting the frame of the load backrest. The ability is recognized in that the frame braces are attached to the frame of the load backrest in such a manner that guard braces do not impede upward mobility of the battery during extraction. Further, when a guard member is present in a bottom portion of the frame, such that the guard member is pivotably coupled to the battery cover and provides space under the frame braces to accommodate the battery cover, neither the load backrest nor the battery cover impedes the battery removal. Further, bends provided in a material forming a body portion of the load backrest provide the body portion with sufficient strength and rigidity compared to conventional load backrests.

The various features, aspects, and embodiments described herein can be used in any combination(s) with one another, or on their own.

It is noted that the terms “substantially” and “about” may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue. The term “substantially” is used herein also to represent the degree by which a quantitative representation may vary from a stated reference without resulting in a change in the basic function of the subject matter at issue. Thus, it is used to represent the inherent degree of uncertainty that may be attributed to any quantitative comparison, value, measurement, or other representation, referring to an arrangement of elements or features that, while in theory would be expected to exhibit exact correspondence or behavior, may in practice embody something less than exact.

Unless otherwise defined, all technical and scientific terms used herein have the same meaning as commonly understood by one of ordinary skill in the art to which the invention belongs. The terminology used in the description herein is for describing particular embodiments only and is not intended to be limiting. As used in the specification and appended claims, the singular forms “a,” “an,” and “the” are intended to include the plural forms as well, unless the context clearly indicates otherwise.

As used herein, the terms “horizontal” and “vertical” are relative terms only, are indicative of a general relative orientation only, and do not necessarily indicate perpendicularity. These terms also may be used for convenience to refer to orientations used in the figures, which orientations are used as a matter of convention only and are not intended as characteristic of the devices shown. The present invention and the embodiments thereof to be described herein may be used in any desired orientation. Moreover, horizontal and vertical walls need generally only be intersecting walls, and need not be perpendicular.

It is noted that one or more of the following claims utilize the term “wherein” as a transitional phrase. For the purposes of defining the present technology, it is noted that this term is introduced in the claims as an open-ended transitional phrase that is used to introduce a recitation of a series of characteristics of the structure and should be interpreted in like manner as the more commonly used open-ended preamble term “comprising.”

It should be understood that where a first component is described as “comprising” or “including” a second component, it is contemplated that, in some embodiments, the first component “consists” or “consists essentially of” the second component. Additionally, the term “consisting essentially of” is used in this disclosure to refer to quantitative values that do not materially affect the basic and novel characteristic(s) of the disclosure.

It should be understood that any two quantitative values assigned to a property or measurement may constitute a range of that property or measurement, and all combinations of ranges formed from all stated quantitative values of a given property or measurement are contemplated in this disclosure.

While particular embodiments have been illustrated and described herein, it should be understood that various other changes and modifications may be made without departing from scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. A load backrest for an industrial vehicle, the load backrest comprising:
a frame attachable to a side structure of the industrial vehicle so as to define an opening between the frame and a vehicle surface of the industrial vehicle; and
a body portion coupled to the frame within the opening of the frame, the body portion comprising an outer portion and a plurality of frame braces that extend at least one of vertically or horizontally from a first side of the outer portion to a second side of the outer portion opposite the first side, the outer portion including:
a face section that is coplanar with the frame braces; and
at least one coupling section that extends transverse to the face section, wherein the at least one coupling section is joined to the face section via a bend in a material forming the body portion, and wherein the second section is coupled to the frame.

2. The load backrest of claim 1, wherein the coupling section is removably coupled to the frame via fasteners.

3. The load backrest of claim 1, wherein a thickness of the frame in a longitudinal direction of the industrial vehicle is greater than a thickness of the frame braces in the longitudinal direction of the industrial vehicle.

4. The load backrest of claim 1, wherein the frame braces are located at a front side of the frame opposite from a battery compartment of the industrial vehicle.

5. The load backrest of claim 1, wherein the frame braces extend vertically and horizontally in a grid pattern.

6. The load backrest of claim 1, wherein the frame braces are integral with the outer portion.

7. The load backrest of claim 1, wherein the coupling section comprises:
an upper coupling section coupled to a top rail of the frame;
a first side coupling section coupled to a first side rail of the frame; and
a second side coupling section opposite the first side coupling section and coupled to a second side rail of the frame opposite the first side rail of the frame.

8. The load backrest of claim 7, wherein:
the upper coupling section is joined to the face section via a first bend in the material forming the body portion;
the first side coupling section is joined to the face section via a second bend in the material forming the body portion; and
the second side coupling section is joined to the face section via a third bend in the material forming the body portion.

9. The load backrest of claim 8, wherein the first side coupling section and the second side coupling section do not engage the upper coupling section.

10. A load backrest for an industrial vehicle, the load backrest comprising:
a frame for attachment to a side structure of the industrial vehicle and defining an opening; and
a body portion coupled to the frame in an upper portion of the opening of the frame, the body portion comprising a plurality of frame braces that extend at least one of vertically or horizontally up to an outer portion of the body portion, the outer portion coupled to the frame; and
a guard member pivotably movable from a closed position in a lower portion of the opening to an open position outside the opening, wherein the guard member is coupled to a battery cover that covers a battery when the guard member is in the closed position and exposes the battery when the guard member is in the open position, wherein the guard member is not coupled to the frame or to the body portion.

11. The load backrest of claim 10, wherein the battery cover is pivotably coupled to a battery compartment above the battery.

12. The load backrest of claim 10, wherein the guard member is moved with the battery cover when the battery cover is opened.

13. The load backrest of claim 10, wherein the guard member comprises a plurality of guard braces that extend at least one of vertically or horizontally within the lower portion of the opening when the guard member is in the closed position.

14. The load backrest of claim 10, wherein the frame braces are located at a front side of the frame opposite from a battery compartment of the industrial vehicle that houses the battery.

15. The load backrest of claim 10, wherein the body portion fills at least 50% of the opening and guard member fills less than 50% of the opening.

16. A method for accessing a battery of an industrial vehicle, wherein the industrial vehicle comprises:
a vehicle body having a battery compartment that houses the battery;
a load handling assembly; and
a load backrest according to claim 10 coupled to a side structure of the industrial vehicle adjacent to the load handling assembly,
the method comprising:
opening a battery cover that is rigidly coupled to the guard member to simultaneously expose the battery and move at least a portion of the guard member outside the opening.

17. The method of claim 16, wherein opening the battery cover causes at least a portion of the battery cover to enter the opening in the frame.

18. The method of claim 16, wherein opening the battery cover comprises pivotably opening the battery cover in a direction toward the load handling assembly.

19. The method of claim 16, wherein at least a majority of the battery cover clears the opening in the frame when the battery cover is opened.

20. The method of claim 16, wherein when the battery cover is open, the battery of the industrial vehicle is upwardly extractable from the battery compartment without removing the load backrest and without adjusting the frame to accommodate extraction of the battery.
